(19) United States
(12) Patent Application Publication
(10) Pub. No.: US 2014/0052502 A1
(43) Pub. Date: Feb. 20, 2014

(54) BALANCED WEB ANALYTICS SCORECARD

(71) Applicants: Nadim Razvi, Speyer (DE); Tobias Rainer Schneider, Mutterstadt (DE)

(72) Inventors: Nadim Razvi, Speyer (DE); Tobias Rainer Schneider, Mutterstadt (DE)

(73) Assignee: SAP AG, Walldorf (DE)

(21) Appl. No.: 13/586,319

(22) Filed: Aug. 15, 2012

(51) Int. Cl. G06Q 10/00

(52) U.S. Cl. 705/7.39

(57) ABSTRACT

A balanced web analytics scorecard comprises perspectives, objectives and measures based on web analytics. The balanced web analytics scorecard comprises at least one perspective relating to web-based activities of an organization, such as a traffic generation perspective, a visitor engagement perspective, a growth and innovation perspective or an e-commerce perspective. The web analytics are based on user interactions with a website. Scores for web analytic-based measures are calculated based on the web analytics, and scores for objectives associated with web analytic-based measures are based on measure scores. Updated balanced web analytics scorecards can be stored on computer-readable media or presented at a display of a computing device.

### BACKGROUND

The balanced scorecard is a performance management tool that enables organizations to clarify their strategy, monitor execution of activities, and monitor consequences arising from those actions. The scorecard presents a mixture of financial and non-financial measures into a single succinct report that comprises both leading and lagging indicators. The balanced scorecard is comprised of perspectives, strategic objectives and measures. The perspectives provide information about an organization from particular views, such as financial, customer or learning and growth views. The strategic objectives (objectives) are goals that an organization desires to reach for the perspectives. A perspective can be associated with one or more objectives. A measure, or key performance indicator (KPI), allows an organization to measure progress toward a particular objective. Multiple measures can be associated with an objective.

### BRIEF DESCRIPTION OF THE DRAWINGS

FIG. 1 is an illustration of an exemplary balanced scorecard.

FIG. 2 is an illustration of an exemplary balanced web analytics scorecard.

FIG. 3 shows exemplary web analytics that can be used as measures in a balanced web analytics scorecard.

FIG. 4 is a block diagram of an exemplary system for managing balanced web analytic scorecards.

FIG. 5 is an exemplary display of a visitor engagement perspective.

FIG. 6 is a graph illustrating a first exemplary use of balanced web analytics scorecards.

FIG. 7 is a graph illustrating a second exemplary use of balanced web analytics scorecards.

FIG. 8 is a diagram illustrating a third exemplary use of balanced web analytics scorecards.

FIG. 9 shows an exemplary method of managing a balanced web analytics scorecard.

FIG. 10 illustrates a generalized example of a suitable implementation environment in which balanced web analytics scorecard embodiments, techniques, and technologies may be implemented.

### DETAILED DESCRIPTION

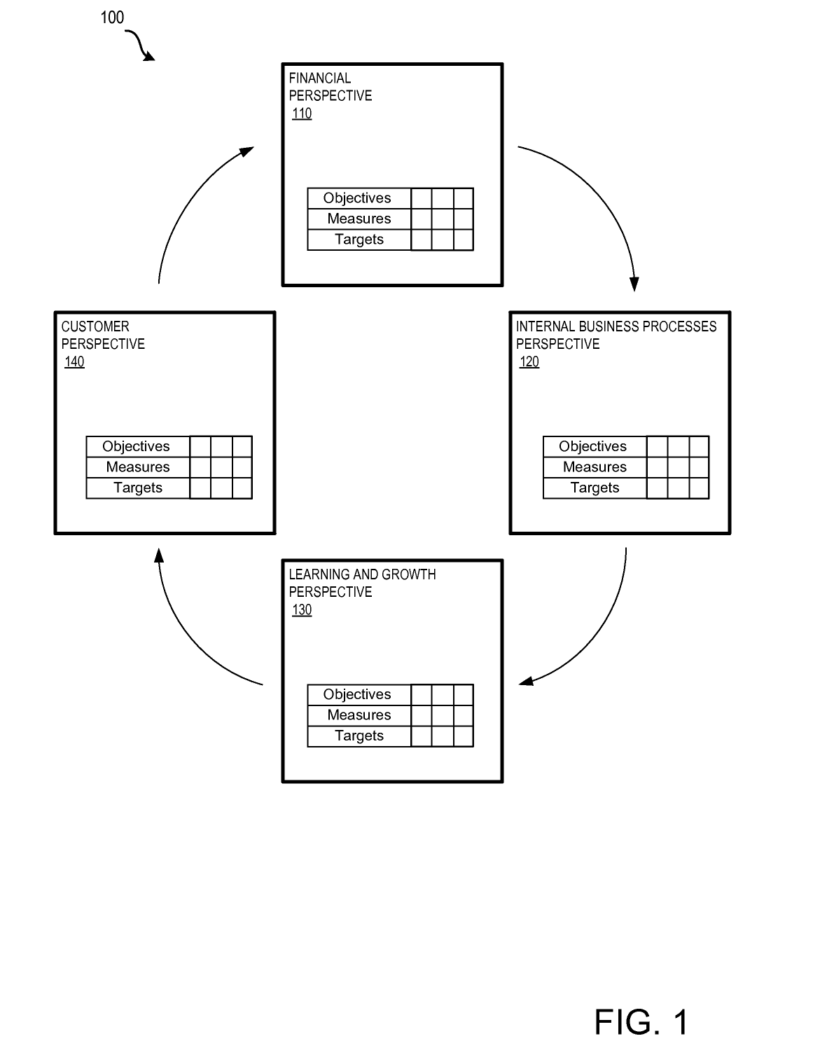

FIG. 1 is an illustration of an exemplary balanced scorecard comprising a financial perspective 110, an internal business processes perspective 120, a learning and growth perspective 130, and a customer perspective 140. The financial perspective 110 relates to the financial status or health of an organization and includes traditional financial data as measures. The internal process perspective 120 relates to internal business processes and allows decision makers to determine how well a business is running and whether its products and services conform to customer requirements. The learning and growth perspective 130 relates to employee training and corporate cultural attitudes related to individual and corporate self-improvement. The customer perspective 140 relates to customer focus and customer satisfaction.

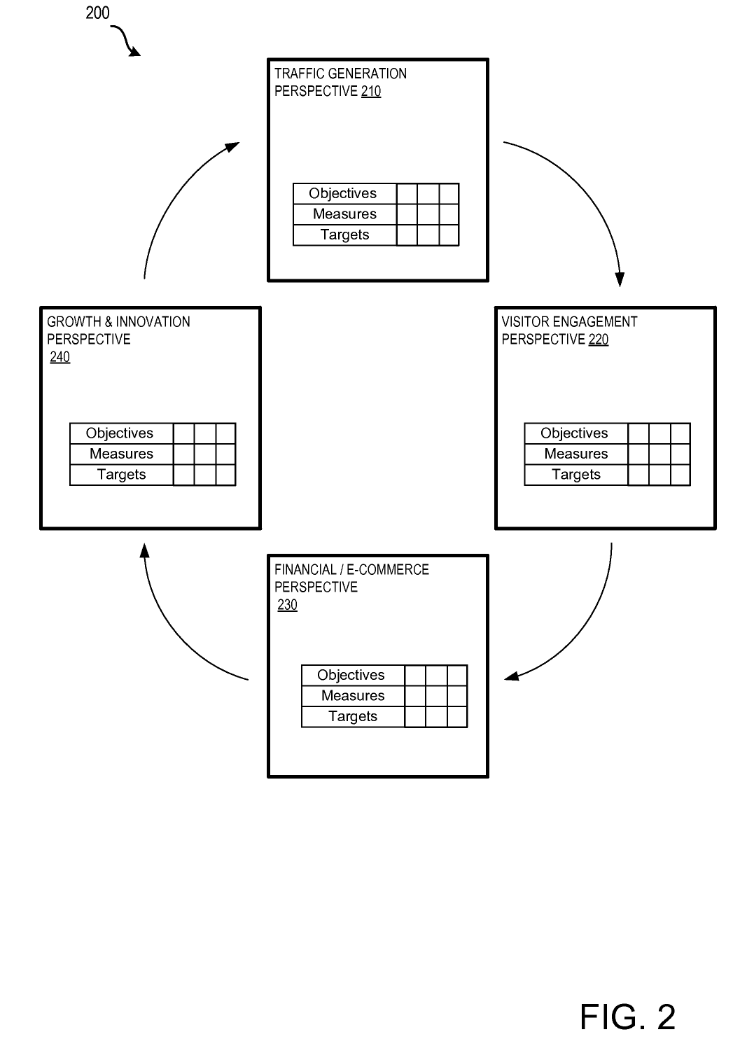

FIG. 2 is an illustration of an exemplary balanced web analytics scorecard (BWSC) 200. Generally, a BWSC is a balanced scorecard that comprises perspectives and objectives relating to an organization's web-related activities, and that uses web analytics as a basis for one or more scorecard measures. In various embodiments, a BWSC focuses on a website of an e-commerce entity, such as a business. Perspectives and objectives relating to an organization's web-based activities are called web-based perspectives and web-based objectives, respectively. It is not necessary that all perspectives and objectives in a BWSC are web-based. A BWSC can comprise perspectives that are not web-based, and a web-based perspective can comprise both web-based objectives and non-web-based objectives.

The BWSC 200 comprises a traffic generation perspective 210, a visitor engagement perspective 220, a financial/e-commerce perspective 230, and a growth and innovation perspective 240. The traffic generation perspective 210 relates to the generation of website traffic and the visitor engagement perspective 220 relates to how users interact with a website. The financial/e-commerce perspective 230 relates to financial data associated with a website and the growth and innovation perspective 240 relates to individual and corporate self-improvement. In other embodiments, a BWSC can comprise more or fewer perspectives than those shown for BWSC 200, but generally comprise at least one web-based perspective. The BWSC perspectives can be named differently than those shown in FIG. 2, but still retain the general focus of the perspective. For example, the financial/e-commerce perspective could be named a financial perspective or e-commerce perspective.

As mentioned above, measures in a BWSC can be based on web analytics. As used herein, the term “web analytics” generally refers to the measurement, collection and analysis of data relating to a website, and information generated or derived therefrom. Thus, in some embodiments, web analytics comprises a plurality of web analytic parameters associated with how users interact with a website, such as how much time a user spends on a website. Web analytics includes directly measureable information, such as how often a user visits a website, and information derived from such measurable information. For example, a “degree of engagement” web analytic can be derived from measureable web analytics such as a user's length of visit and depth of visit.

Web analytics include on-site and off-site web analytics. On-site web analytics corresponds to user activity occurring once a user is on a website and can track, for example, the number of visitors to a website, the length and depth of a visit to a website, and which pages within a website result in a purchase (or other conversion) by a user. Off-site web analytics corresponds to website-related measurement, collection and analysis separate from user activity on a website. Examples of off-site web analytics include information regarding a website's potential audience, visibility, and comments about or “buzz” generated by a website.

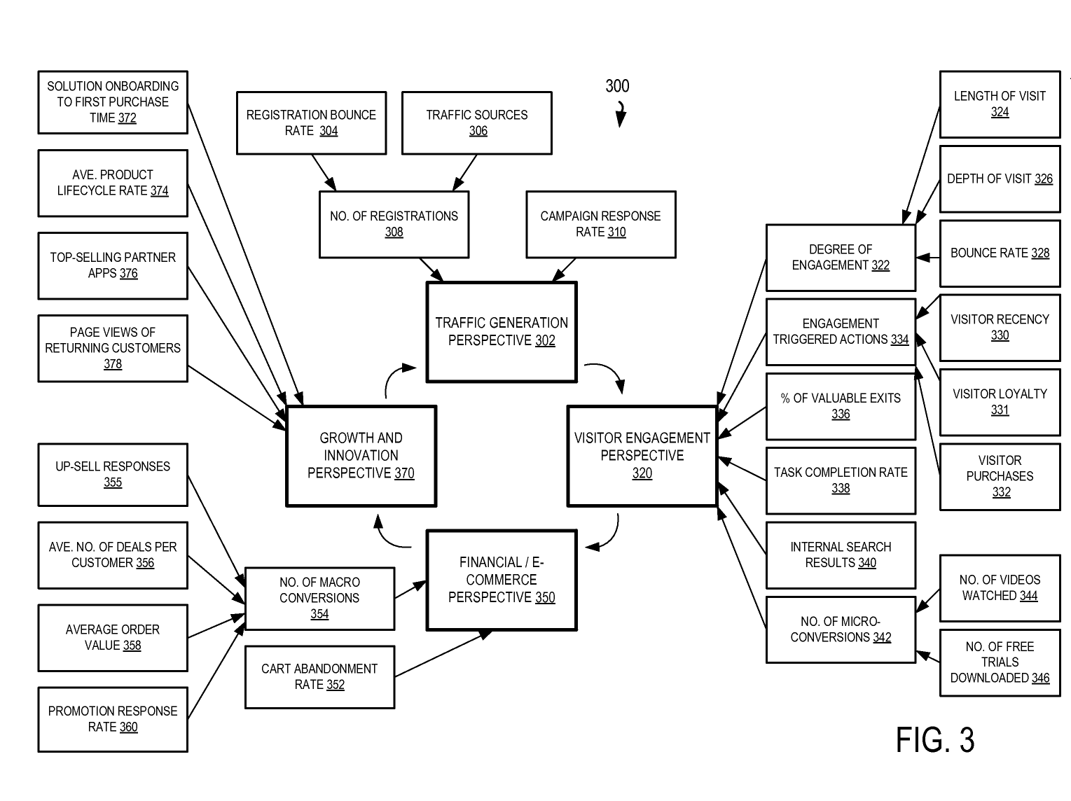

FIG. 3 shows exemplary web analytics that can be used as measures in a BWSC. Not all of the web analytics shown in FIG. 3 are meant to be included in a particular BWSC. Rather, FIG. 3 is meant to convey only some of the possible web analytics that can be used as BWSC measures for web-related perspectives.

Web analytics can be used as the basis for measures associated with the four web-related perspectives shown in the BWSC 300. The traffic generation perspective 302 is shown as being associated with the following web analytic-based measures: registration bounce rate 304, traffic sources 306, number of registrations 308 and campaign response rate 310. Registration bounce rate 304 is a measure of the portion of users who attempt to register at a website (as a customer, member, etc.) as compared to the number of users who actually complete the registration. Traffic sources 306 indicate the sources from which traffic to the website originated, such as other websites. Campaign response rate 310 is a measure of the rate at which users who received campaign materials or communications (e.g., email, physical mailings, invites via social networks) actually registered at the website for a particular campaign. Number of registrations 308 is the number of users that have registered at the website. A user can register at a website for various reasons, such as to receive an organization's newsletter or product updates. The number of registrations 308 is shown as being based on registration bounce rate 304 and traffic sources 306. In other embodiments, the number of registrations 308, and any other web analytic in FIG. 3 shown as being derived from other web analytics, can be determined from more or fewer web analytics, or measured directly (i.e., not derived from other web analytics). In general, two or more web analytics can be combined to form new web analytics.

The visitor engagement perspective 320 is shown as being associated with the following web analytic-based measures: degree of engagement 322, engagement-triggered actions 334, percentage of valuable exits 336, task completion rate 338, internal search results 340 and number of micro-conversions 342. Degree of engagement 322 is a measure of the extent to which a visitor engages with a website. Degree of engagement 322 can be based on one or more of the following web analytics: length of visit 324, depth of visit 326 and bounce rate 328 (the number of visits to a website resulting in only one page view). Depth of visit 326 can indicate, for example, the number of unique pages within a website visited by a user. Engagement-triggered actions 334 can be based on one or more of the following web analytics: visitor recency 330 (the time between visits by a particular user), visitor loyalty 331 (the number of repeat visits by a user) and visitor purchases 332.

Percentage of valuable exits 336 indicates the portion of exits from a website resulting in a sale or other transaction resulting in a value to an organization, such as a donation. Task completion rate 338 indicates the completion rate of the task that a user intended to perform on the website (e.g., purchase a product, find technical support or contact information, check product prices). The task completion rate 338 can be determined by, for example, a user's response to a survey presented to the user upon exit from the website. Internal search results 340 can comprise search terms supplied by users for searches within the website and the results of those searches. The number of micro-conversions 342 is a measure of the conversions resulting from visits that are not an organization's main conversion goal, but are conversions that are still of value to the organization. The number of micro-conversions 342 can be based on, for example, the number of videos watched 344 and a number of free trials (e.g., 30-day free software trial) downloaded 346 by a visitor. The number of micro-conversions 342 can be based on additional web analytics such as a number of white papers downloaded, a number of subscriptions to an email newsletter or RSS feed and the like.

The financial/e-commerce perspective 350 is shown as being associated with the following web analytic-based measures: cart abandonment rate 352 and number of macro-conversions 354. Cart abandonment rate 352 indicates a rate at which visitors abandoned a cart in which they had placed at least one item. The number of macro-conversions 354 is a measure of the number of conversions made by visitors that are an organization's main conversion goal (typically, sales). The number of macro-conversions 354 can be based on a number of up-sell responses 355, an average number of deals per customer 356, an average order value 358, and a promotion response rate 360. The number of up-sell responses 355 can be based on, for example, a recommendation engine response rate. The average number of deals per customer 356 can comprise, for example, the average number of discounts provided to a customer (e.g., free shipping resulting from the user purchasing more than a set amount of goods or services). The promotion response rate 360 can be, for example, a rate at which users who were provided a coupon (via email, social networking message) redeemed the coupon at the website.

The growth and innovation perspective 370 is shown as being associated with the following web analytic-based measures: solution onboarding to first purchase time 372 (e.g., the time from when a solution, such as a good or service, is made available on a website to when it is purchased for the first time), average product lifecycle time 374 (e.g., a measure of the average lifecycle of a solution on an e-commerce entity, such as the time from when the a product is first made available on a website to the product's replacement by, for example, a new product or a new version of the same solution), top-selling partner applications 376 and page views of returning customers 378.

Web analytics that comprise a quantitative measure, such as those that provide a rate or a number (e.g., visitors, sales) can be determined over one or more specified recent time periods (e.g., hour, day, week, month, year), within a specified date range, since a specified date (e.g., a campaign launch date, a date the website went live) or other time period.

In various embodiments, a BWSC can contain more or fewer perspectives than those shown in FIG. 3. For example, a BWSC with two perspectives can contain a traffic generation perspective and a visitor engagement perspective. In various embodiments where the BWSC focuses on the performance measurement of an e-commerce entity, the BWSC measures can be comprised predominantly (or entirely) of web analytic-based measures.

In addition, a BWSC can include web analytics in addition to those shown in FIG. 3. Additional BWSC web analytic-based measures include a visitor's geolocation (as determined by, for example, an IP (Internet Protocol) address), click analytics (which provide information as to where on a website a user has clicked), and customer lifecycle analytics (e.g., analytics that track a particular user's behavior at a website over time). Web analytics can also comprise information indicating website effectiveness resulting from A/B or multivariate testing that tests the impact of a change in a website on user behavior, such as an increase in macro- or micro-conversion rates.

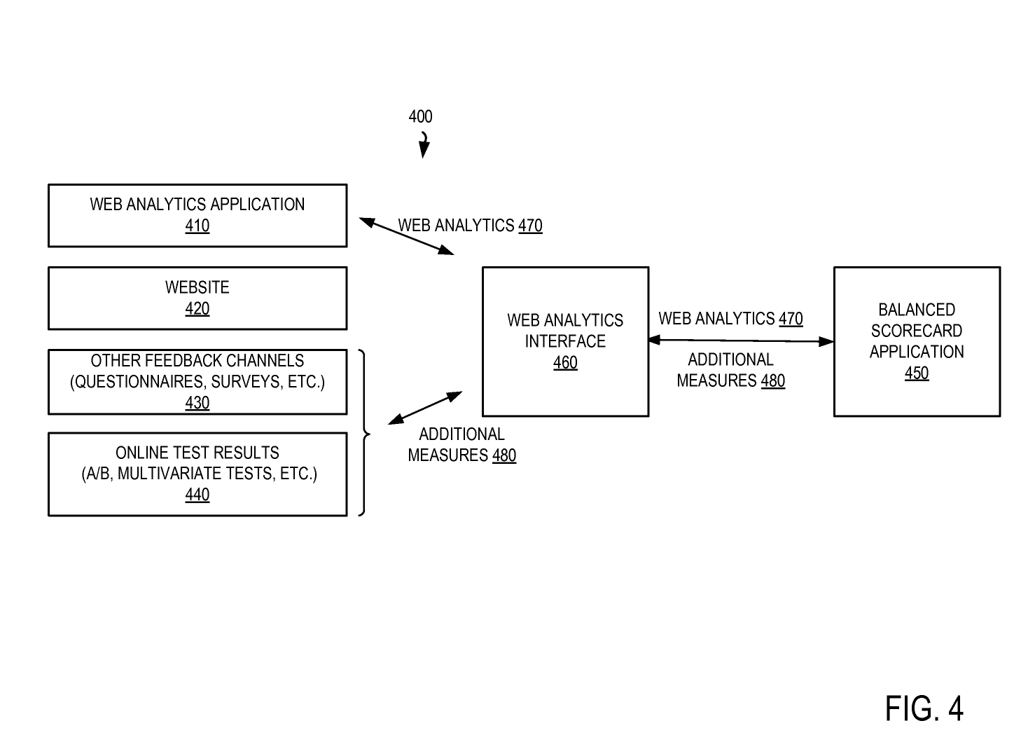

FIG. 4 is a block diagram of an exemplary system 400 for managing balanced web analytic scorecards. Balanced web analytics scorecard management includes tasks associated with maintaining a balanced web analytic scorecard in a computing environment, such as the generation, collection, measurement of web analytics and other tasks associated with web analytics; the calculation of scorecard objective and measures scores; and the updating, storing and displaying of BWSCs. The system 400 comprises web analytics application 410, a website 420, other feedback channels 430, online tests 440, balanced scorecard application 450 and web analytics interface 460. Web analytics application 410 can be an application (e.g., in-house or third party) that generates web analytics 470 based on user interaction with the website 420. For example, web analytics can be generated by commercially available web analytics tools and/or back-end servers of an organization's online store.

User interaction with the website 420 comprises actions taken by users to interact with a website presented at a display of a computing device. User interaction includes user selection of actionable objects in a web page, such as selecting hyperlinks; filling out online forms to, for example, fill out a registration, enter information to complete a purchase; and the like. User interaction with a website is typically based on user input provided to a computing device via, for example, an input device such as keyboard, mouse or touch display. User input can also be provided via one or more natural user interfaces. For example, the computing device can comprise speech recognition software as part of a voice interface that allows a user to operate a computing device via voice commands. Further, a computing device can comprise an input device and software that allows a user to interact with the computing device via a user's spatial gestures (e.g., waving an arm or a hand).

Web analytics application 410 can generate the web analytics 470 by, for example, analyzing web server log files, page tagging or by any other method, and deliver the web analytics 470 to the web analytics interface 460. The web analytics application 410 can comprise software components that are integrated into the website 420, such as JavaScript tags.

Website 420 is a website for which the web analytics 470 are generated. The other feedback channels 430 comprise channels that provide additional data that can be used for BWSC measures, or from which such measures can be derived, such as surveys or questionnaires presented to the user while visiting the website or delivered to users via physical mail, email, social media messaging systems and the like. The online test results 440 comprises further sources of information that can be used as BWSC measures (or form a basis for such measures) and include the results or information generated from the results of A/B or multivariate testing. The other feedback channels 430 and online test results 440 generate additional measures 480 that are provided to the web analytics interface 460.

Balanced scorecard application 450 can be any software application that utilizes balanced scorecards to present information about an organization's activities to a user. In some embodiments, the balanced scorecard application 450 comprises enterprise resource planning software.

The web analytics interface 460 receives the web analytics 470 from the web analytics application 410 and the additional measures 480 from the other feedback channels 430 and the online tests 440 and passes the web analytics 470 and the additional measures 480 to the balanced scorecard application 450. In various embodiments, the web analytics interface 460 is a plug-in to an existing balanced scorecard application 450 that enables the existing application 450 to use the web analytics 470 and the additional feedback 480 as the basis for balanced scorecard measures. In other embodiments, the balanced scorecard application 450 is configured to receive web analytics from external sources. The web analytics interface 460 can be configured to derive new web analytics based on the web analytics 470 received from the web analytics application 410, and include these new web analytics to the balanced scorecard tools. These new web analytics can be user-defined.

The web analytics 470 and additional measures 480 can be collected by the web analytics interface 460 and passed along to the balanced scorecard application 450 in real-time. The interface 460 can request web analytics from the web analytics applications 410, other feedback channels 430 and online tests 440 on a periodic (e.g., hourly, daily, weekly) or other basis. In other embodiments, the web analytics application 410, other feedback channels 430 and online tests 440 can provide the web analytics 470 and additional measures 480 on a periodic or other basis, independent of requests received from the web analytics interface 460.

In a BWSC, scores can be associated with scorecard objectives (objective scores) and measures (measure scores). A measure score can be a web analytic (e.g., average length of visit, as measured in number of minutes) or calculated from a web analytic (e.g., length of visit, converted to a scale of 1 to 100; micro-conversion rate as derived from other web analytics). Target scores (targets) can be associated with measures and objectives as well, and reflect a goal for the organization with respect to a particular measure or objective. Assigning targets to web analytic measures and objectives can facilitate the presentation of a balanced web analytics scorecard in which it is easy for a user to identify which measures and objectives have met their target. For example, when presented at a computing device display, the font, color or other characteristic of text corresponding to a web analytic measure or objective can be based on the value of the measure's or objective's score relative to the corresponding target score. In some embodiments, a status icon can be displayed near a measure or objective to indicate how a measure or objective's score compares to a target score.

An objective score can be calculated based on scores for measures associated with the objective. Any formula or algorithm can be used for determining an objective score from measure scores. For example, an objective score can be the sum, average or a weighted average of measure scores. Scores can be calculated when web analytics are received at a web analytics interface or balanced scorecard application, or at any other time. Thus, BWSC scores can be calculated in real-time, allowing organization personnel to view a current state of the organization, based on recently generated web analytics.

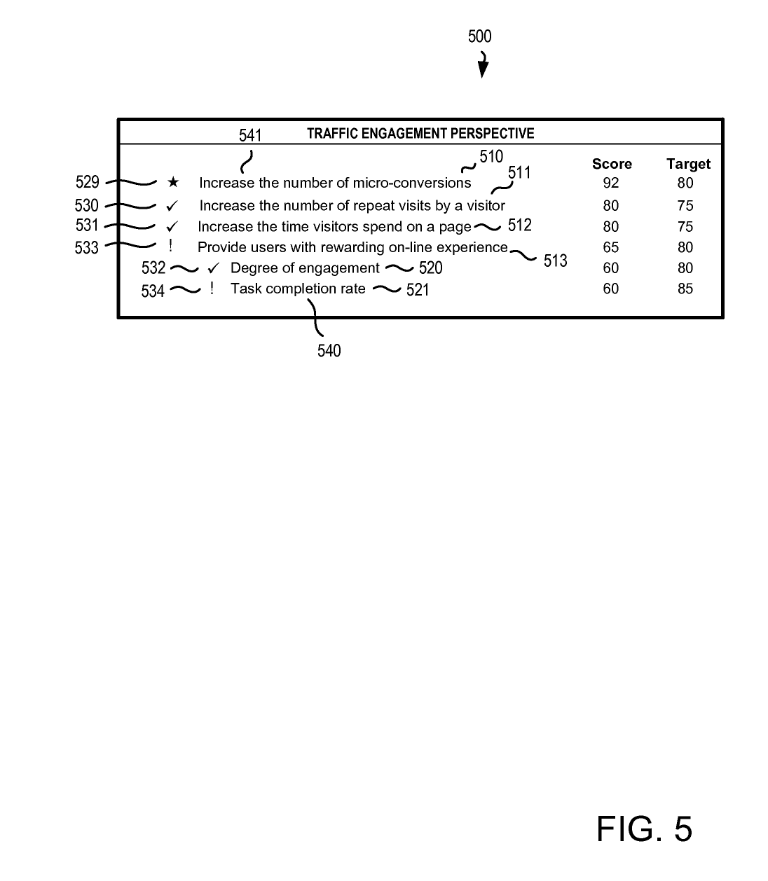

FIG. 5 shows an exemplary display of a visitor engagement perspective 500 of a BWSC comprising objectives 510-513 and measures 520-521. The visitor engagement perspective 500 can be displayed as part of a display showing more than one perspective in a BWSC, or without any other perspectives, as shown in FIG. 5. The display 500 comprises three columns: a text column, a score column and a target score column. The objectives 510-513 comprise a first objective 510 “Increase the number of micro-conversions,” a second objective 511 “Increase the number of repeat visits by a visitor,” a third objective 512 “Increase the time visitors spend on a page,” and a fourth objective 513 “Provide users with a rewarding online experience.” Measures 520-521 are associated with the fourth objective 513 and include the web analytic-based measures degree of engagement and task completion rate.

The visitor engagement perspective 500 comprises status icons indicating how measure and objective scores compare to target scores. The checkmark and status icons 529-532 indicate that a measure or objective score has met or exceeded its target. The exclamation point status icons 533 and 534 indicate that a measure or objective score is below its target. Other status icons can be used to indicate whether a measure or objective score meets its target or not. In various embodiments, the text corresponding to a measure or objective can be displayed in a color (font, style, etc.) that uses the score. For example, text 540 could be displayed in red or yellow to indicate that the task completion rate score is below its target score, and text 541 corresponding to objective 510 could be displayed in green to indicate that its score exceeds its target.

In some embodiments, a measure or objective can have multiple target scores. For example, objective 510 could have target scores of 50 and 80 representing, for example, a basic goal and a “stretch” goal. For measures with more than one target score, different status icons or different types of text formatting can be displayed or used to indicate how a measure/objective score compares to the target scores. For example, the star status icon 529 can indicate that the score of objective 510 (92) exceeds its greatest target score (80).

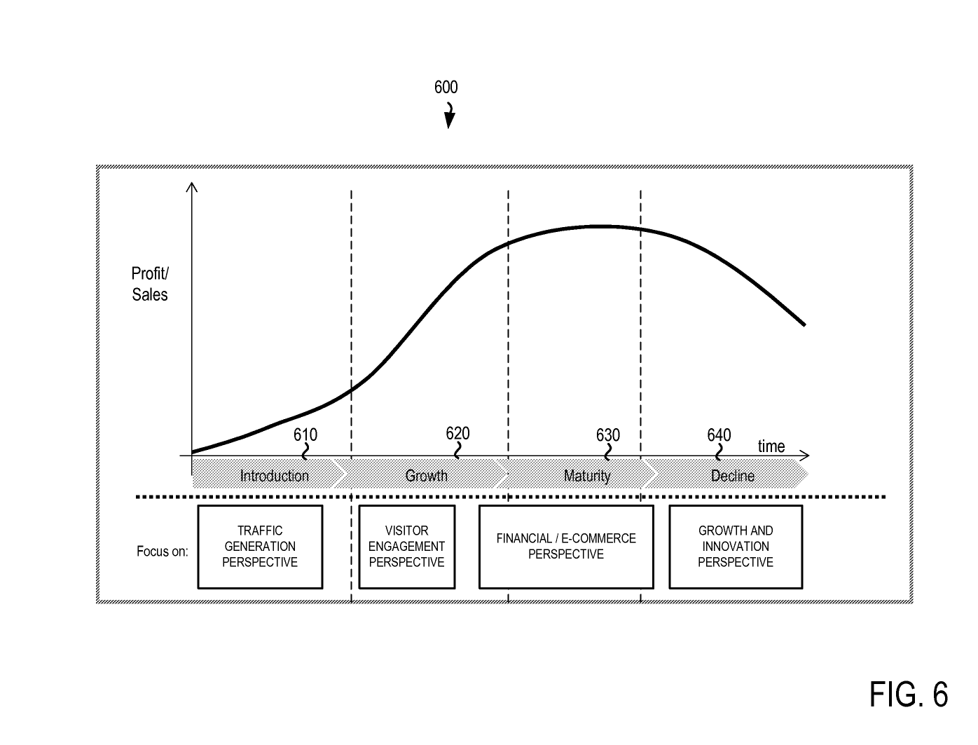

FIG. 6 shows a graph 600 illustrating a first exemplary use of balanced web analytics scorecards. The graph 600 shows how the focus of an organization on various BWSC perspectives can change over a product life cycle. In the graph 600, the focus in an introduction phase 610 is on a traffic generation perspective, the focus in a growth phase 620 is on a visitor engagement perspective, the focus in a maturity phase 630 is on a financial/e-commerce perspective, and the focus in a decline phase 640 is on a growth and innovation perspective. In other usage scenarios, an organization's focus can be on different (or additional) perspectives in the various product life cycle phases than those shown in FIG. 6.

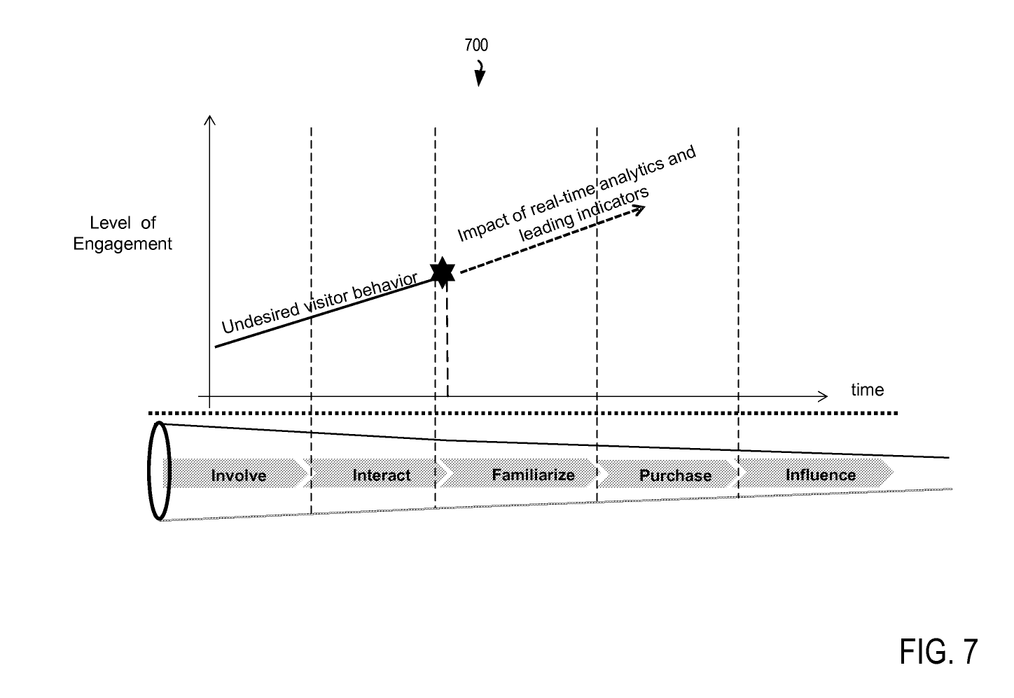

FIG. 7 shows a graph 700 illustrating a second exemplary use of BWSCs. The graph 700 shows a level of visitor engagement at a website over time. In the second exemplary use, a BWSC can enable the early detection of unintended visitor behavior and aid in increasing the effectiveness of real-time web analytics. A BWSC distinguishes between leading and lagging indicators, and the leading indicators can aid in predicting these undesirable behavior patterns.

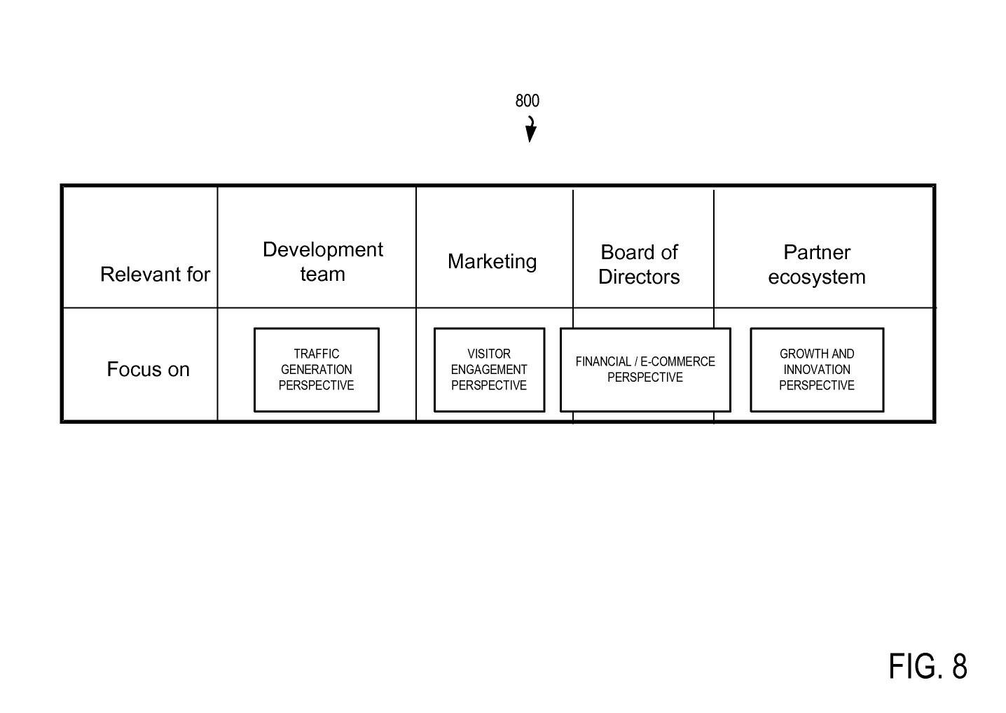

FIG. 8 shows a diagram 800 illustrating a third exemplary use of BWSCs. The diagram 800 illustrates that a BWSC can enable personalized results to be displayed for various stakeholders within an organization. As shown in FIG. 8, the focus of a BWSC displayed for a web development team can be a traffic generation perspective, the focus of a BWSC displayed for a marketing team can be a visitor engagement perspective, the focus of a BWSC displayed for a board of directors can be a financial/e-commerce perspective, and the focus of a BWSC displayed for persons belonging to a partner ecosystem (e.g., investors, suppliers) can be a growth and innovation perspective. Displaying a BWSC for a stakeholder with a focus on a particular perspective can comprise displaying only the perspective of interest or displaying an expanded view of the perspective under focus (e.g., displaying the perspective with all of its objectives and all of its measures).

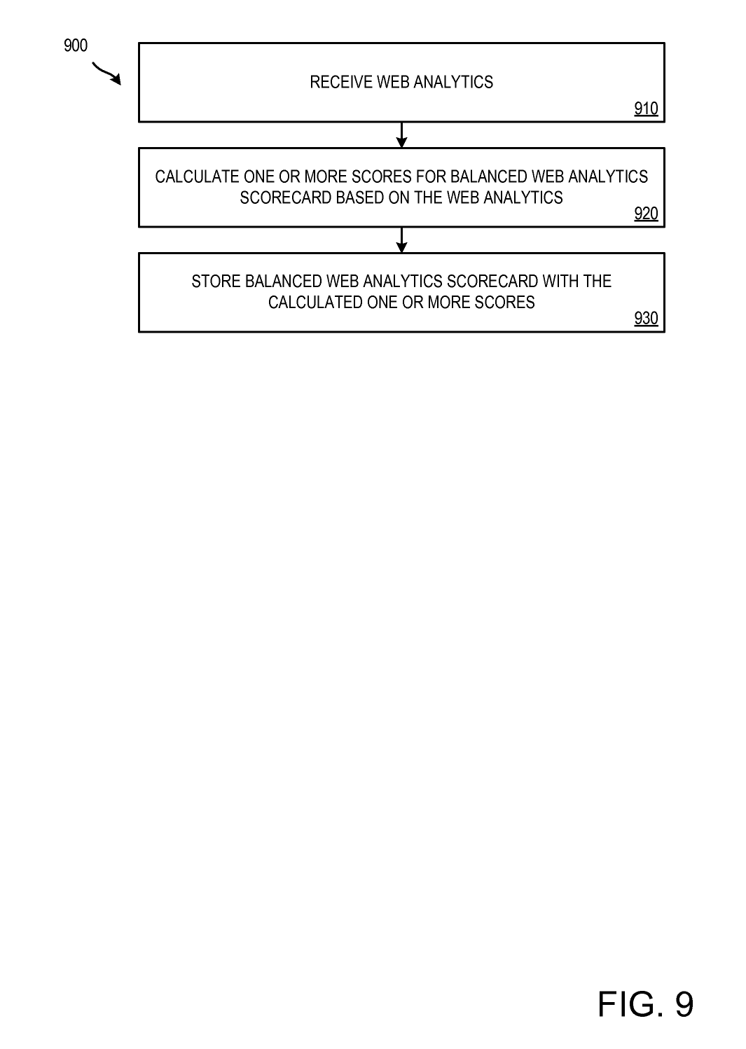

FIG. 9 shows an exemplary method 900 of managing a balanced web analytics scorecard. The method can be performed by, for example, one or more computing devices executing a balanced scorecard application and a web analytics interface that receives web analytics from a third-party web analytics application configured to determine web analytics for an organization's online store. The balanced scorecard application maintains a BWSC that comprises a visitor engagement perspective. The visitor engagement perspective comprises a “provide users with a rewarding shopping experience.”

At 910, web analytics based on user interaction with a website are received. In the example, the computing device executing the web analytics interface receives web analytics provided by the third-party web analytics application based on user interaction with the online store, and passes these web analytics to the computing device executing the balanced scorecard application.

At 920, one or more scores for the balanced web analytics scorecard are calculated based on the received web analytics. The balanced web analytics scorecard comprises a plurality of perspectives, a plurality of objectives and a plurality of measures, the plurality of perspectives comprising a traffic generation perspective. The one or more scores comprise an objective score associated with one of the plurality of objectives. In the example, the computing device executing the balanced scorecard application calculates an objective score for the “provide users with a rewarding shopping experience” objective.

At 930, the balanced web analytics scorecard with the calculated one or more scores is stored in one or more computer-readable storage media. In the example, the balanced scorecard with the updated score for the “provide users with a rewarding shopping experience” objective is stored on a hard drive local to the computing device executing the balanced scorecard application.

The disclosed balanced web analytics scorecard technologies have at least the following exemplary utilities. First, BWSCs allow an organization's web-based activities to be incorporated into a balanced scorecard through the introduction of web-based perspectives, objectives and measures. Second, BWSCs can be updated in real-time as updated web analytics become available. Third, a web analytics interface can be used to leverage existing web analytics applications and balanced scorecard applications.

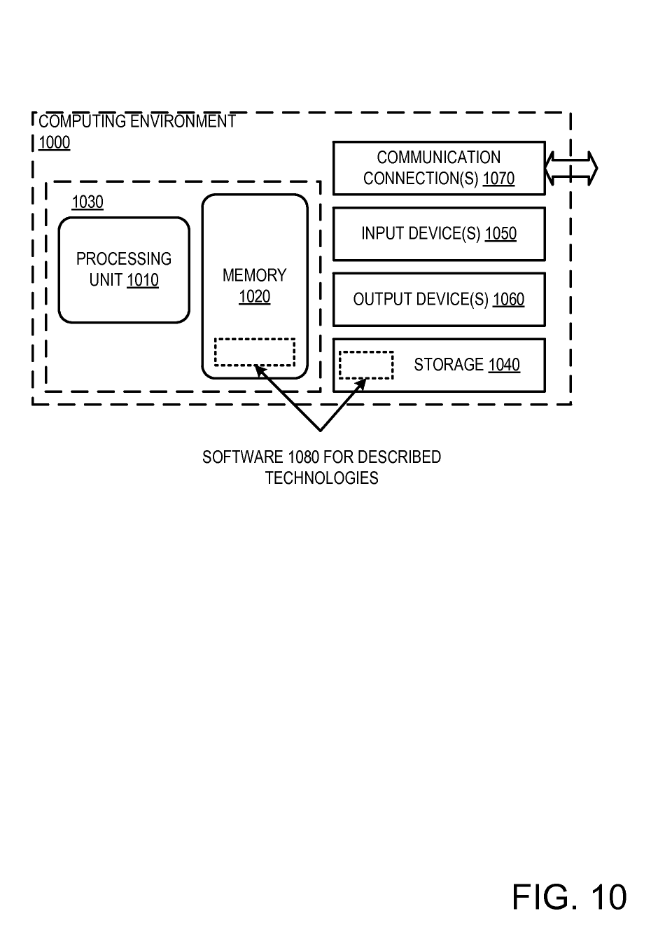

FIG. 10 illustrates a generalized example of a suitable computing environment 1000 in which balanced web analytics scorecard embodiments, techniques, and technologies can be implemented. The computing environment 1000 can correspond to any of the computing devices described herein. The computing environment 1000 is not intended to suggest any limitation as to scope of use or functionality of the technology, as the technology can be implemented in diverse general-purpose or special-purpose computing environments. For example, the disclosed technology can be implemented using one or more computing devices (e.g., a server, desktop, laptop, hand-held device, mobile device, tablet, smartphone), the computing devices comprising a processing unit, memory and storage storing computer-executable instructions implementing the technologies described herein. The disclosed technology can also be implemented with other computer system configurations, including multiprocessor systems, microprocessor-based or programmable consumer electronics, network PCs, minicomputers, mainframe computers, a collection of client/server systems and the like. The disclosed technologies can also be practiced in distributed computing environments where tasks are performed by remote processing devices that are linked through a communications network, such as the Internet. In a distributed computing environment, program modules can be located in both local and remote memory storage devices.

With reference to FIG. 10, the computing environment 1000 includes at least one central processing unit 1010 and memory 1020. In FIG. 10, this most basic configuration 1030 is included within a dashed line. The central processing unit 1010 executes computer-executable instructions. In a multi-processor system, multiple processing units execute computer-executable instructions to increase processing power and as such, multiple processors can be running simultaneously. The memory 1020 can be volatile memory (e.g., registers, cache, RAM), non-volatile memory (e.g., ROM, EEPROM, flash memory, etc.), or some combination of the two. The memory 1020 stores software 1080 that can, for example, implement the technologies described herein. A computing environment can have additional features. For example, the computing environment 1000 includes storage 1040, one or more input devices 1050, one or more output devices 1060 and one or more communication connections 1070. An interconnection mechanism (not shown) such as a bus, a controller, or a network, interconnects the components of the computing environment 1000. Typically, operating system software (not shown) provides an operating environment for other software executing in the computing environment 1000, and coordinates activities of the components of the computing environment 1000.

The storage 1040 can be removable or non-removable, and includes magnetic disks, magnetic tapes or cassettes, CD-ROMs, CD-RWs, DVDs, or any other tangible storage medium which can be used to store information and which can be accessed within the computing environment 1000. The storage 1040 stores instructions for the software 1080, which can implement technologies described herein.

The input device(s) 1050 can be a touch input device, such as a keyboard, keypad, mouse, touchscreen, pen, or trackball, a voice input device, a scanning device, a natural user interface (e.g., capable of voice or gesture recognition) or another device that provides input to the computing environment 1000. For audio, the input device(s) 1050 can be a sound card or similar device that accepts audio input in analog or digital form, or a CD-ROM reader that provides audio samples to the computing environment 1000. The output device(s) 1060 can be a display, printer, speaker, CD-writer or another device that provides output from the computing environment 1000.

The communication connection(s) 1070 enable communication over a communication medium (e.g., a connecting network) to other computing entities. The communication medium conveys information such as computer-executable instructions, compressed graphics information or other data in a modulated data signal.

Any of the disclosed methods can be implemented as computer-executable instructions or a computer program product. Such instructions can cause a computing device to perform any of the disclosed methods. The computer-executable instructions or computer program products as well as any data created and used during implementation of the disclosed embodiments can be stored on one or more computer-readable storage media (e.g., non-transitory computer-readable storage media, such as optical media discs (such as DVDs or CDs), volatile memory components (such as DRAM or SRAM), or nonvolatile memory components (such as flash memory or hard drives)) and executed on a computing device. Computer-readable storage media does not include propagated signals.

The computer-executable instructions can be part of, for example, a dedicated software application or a software application that is accessed or downloaded via a web browser or other software application (such as a remote computing application). Such software can be executed, for example, on a single local computing device or in a network environment (e.g., via the Internet, a wide-area network, a local-area network, a client-server network (such as a cloud computing network), or other such network) using one or more network computing devices. The storage 1020 and 1040 are computer-readable storage media.

Furthermore, any of the methods described herein can be implemented by computer-executable instructions stored in one or more computer-readable storage devices, such as hard disk drives, floppy disk drives, memory integrated circuits, memory modules, solid-state drives and other electronic devices comprising computer-readable storage media.

For clarity, only certain selected aspects of the software-based implementations are described. Other details that are known in the art are omitted. For example, it is to be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computing device to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

The disclosed methods, apparatuses, and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Having illustrated and described the principles of the illustrated embodiments, the embodiments can be modified in various arrangements while remaining faithful to the concepts described above. In view of the many possible embodiments to which the principles of the illustrated embodiments may be applied, it should be recognized that the illustrated embodiments are only examples and should not be taken as limiting the scope of the disclosure. We claim all that comes within the scope of the appended claims.

1. A method of managing a balanced web analytics scorecard using one or more computing devices, the method comprising:
receiving web analytics based on user interaction with a website;
calculating, using the one or more computing devices, one or more scores for the balanced web analytics scorecard based on the received web analytics, the balanced web analytics scorecard comprising a plurality of perspectives, a plurality of objectives and a plurality of measures, the plurality of perspectives comprising a traffic generation perspective associated with the user interaction with the website, the one or more scores comprising an objective score associated with one of plurality of objectives; and
storing the balanced web analytics scorecard with the calculated one or more scores in one or more computer-readable storage media.

2. The method of claim 1, wherein the one or more scores further comprise one or more measure scores associated with one or more of the plurality of measures, the calculating comprising calculating the objective score based on the one or more measure scores.

3. The method of claim 1, wherein the web analytics are received from one or more web analytics applications.

4. The method of claim 1, wherein the web analytics are received by a web analytics interface, the calculating is performed at least in part by a balanced scorecard application, the method further comprising the web analytics interface sending the web analytics to the balanced scorecard application.

5. The method of claim 1, further comprising displaying a graphical representation of the balanced web analytics scorecard at a display of a computing device.

6. The method of claim 5, wherein the objective score is associated with one or more target scores and associated with a displayed objective displayed in the graphical representation, and the graphical representation comprises text associated with the displayed objective, a characteristic of the text being dependent on the objective score relative to the one or more target scores.

7. The method of claim 5, wherein the objective score is associated with one or more target scores and associated with a displayed objective displayed in the graphical representation, and the graphical representation comprises a status icon dependent on the objective score relative to the one or more target scores.

8. The method of claim 1, wherein the plurality of perspectives comprises a financial perspective; the web analytics comprise financial web analytics comprising one or more of a cart abandonment rate, a promotion response rate, an average order value, an average number of deals per customer, an up-sell response rate, and a number of macro-conversions; and the one or more scores comprise at least one score associated with the financial perspective calculated based on the financial web analytics.

9. The method of claim 1, wherein the plurality of perspectives comprises a growth and innovation perspective.

10. The method of claim 9, wherein the web analytics comprise growth and innovation web analytics comprising one or more of a solution onboarding to first purchase time, an average product lifecycle time, a list of one of more top-seller partner applications, and a number of page views for returning visitors; and the one or more scores comprise at least one score associated with the growth and innovation perspective calculated based on the growth and innovation web analytics.

11. The method of claim 1, wherein the web analytics comprises traffic generation web analytics comprising one or more of one or more traffic sources, a registration bounce rate, a number of registrations and a campaign response rate; and the one or more scores comprise at least one score associated with the traffic generation perspective calculated based on the traffic generation web analytics.

12. The method of claim 1, wherein the plurality of perspectives comprises a visitor engagement perspective.

13. The method of claim 12, wherein the web analytics comprises visitor engagement web analytics comprising one or more of a length of visit, a depth of visit, a bounce rate, a visitor recency, a visitor loyalty, a number of visits before purchase, a number of videos watched and a number of free trials downloaded, a percentage of valuable exits, a task completion rate; and internal search results, and the one or more scores comprise at least one score associated with the visitor engagement perspective calculated based on the visitor engagement traffic web analytics

14. The method of claim 1, wherein the balanced web analytics scorecard focuses on a website.

15. One or more computer-readable storage media storing computer-executable instructions for causing one or more computing devices to perform a method, the method comprising:
receiving web analytics comprising a plurality of web analytic parameters associated with how users interact with a website;
calculating an objective score for an objective associated with a traffic generation perspective of a balanced web analytics scorecard based on at least one of the plurality of web analytic parameters; and
storing the balanced web analytics scorecard with the calculated objective score.

16. The one or more computer-readable storage media of claim 15 wherein the balanced web analytics scorecard further comprises a financial perspective and the plurality of web analytic parameters comprise one or more financial web analytic parameters, the method further comprising calculating a financial objective score for a financial objective associated with the financial perspective based on at least one of the one or more financial web analytic parameters, the one or more financial web analytic parameters comprising one or more of a cart abandonment rate, a promotion response rate, an average order value, an average number of deals per customer, and an up-sell response rate.

17. The one or more computer-readable storage media of claim 15, wherein the balanced web analytics scorecard further comprises a growth and innovation perspective and the plurality of web analytic parameters comprises one or more growth and innovation web analytic parameters, the method further comprising calculating a growth and innovation objective score for a growth and innovation objective associated with the growth and innovation perspective based on at least one of the one or more growth and innovation web analytic parameters, the one or more growth and innovation web analytic parameters comprising one or more of a solution onboarding to first purchase time, an average product lifecycle time, a list of one of more top-seller partner applications, and a number of page views for returning visitors.

18. The one or more computer-readable storage media of claim 15, wherein the balanced web analytics scorecard further comprises a traffic perspective and the plurality of web analytic parameters comprises one or more traffic web analytic parameters, the method further comprising calculating a traffic objective score for a traffic objective associated with the traffic perspective based on at least one of the one or more traffic web analytic parameters, the one or more traffic web analytic parameters comprising one or more of one or more traffic sources, a registration bounce rate, a number of registrations and a campaign response rate.

19. The one or more computer-readable storage media of claim 15, wherein the balanced web analytics scorecard further comprises a visitor engagement perspective and the plurality of web analytic parameters comprises one or more visitor engagement web analytic parameters, the method further comprising calculating a visitor engagement objective score for a traffic objective associated with the visitor engagement perspective based on at least one of the one or more visitor engagement web analytic parameters, the one or more visitor engagement web analytic parameters comprising one or more of a length of visit, a depth of visit, a bounce rate, a visitor recency, a visitor loyalty, a number of visits before purchase, a number of videos watched and a number of free trials.

20. At least one computing device programmed to carry out a method, the method comprising:
receiving web analytics based on user interaction with a website, the web analytics comprising:
financial web analytics comprising one or more of a cart abandonment rate, a promotion response rate, an average order value, an average number of deals per customer, and an up-sell response rate;
growth and innovation web analytics comprising one or more of a solution onboarding to first purchase time, an average product lifecycle time, a list of one of more top-seller partner applications, and a number of page views for returning visitors;
traffic generation web analytics comprising one or more of one or more traffic sources, a registration bounce rate, a number of registrations and a campaign response rate; and
visitor engagement web analytics comprising one or more of a length of visit, a depth of visit, a bounce rate, a visitor recency, a visitor loyalty, a number of visits before purchase, a number of videos watched and a number of free trials downloaded, percentage of valuable exits, a task completion rate; and internal search results;
calculating one or more scores for a balanced web analytics scorecard based on the web analytics, the balanced web analytics scorecard comprising a traffic generation perspective, a visitor engagement perspective, a financial perspective and a growth and innovation perspective, the calculating comprising:
calculating a financial score for the financial perspective based on the financial web analytics;
calculating a traffic generation score for the traffic generation perspective based on the financial web analytics;
calculating a visitor engagement score for the visitor engagement perspective based on the financial web analytics; and
calculating a growth and innovation score for the growth and innovation perspective based on the financial web analytics; and
storing the balanced web analytics scorecard with the calculated one or more scores in one or more computer-readable storage media.
